(19) United States
(12) Patent Application Publication
(10) Pub. No.: US 2006/0289732 A1
(43) Pub. Date: Dec. 28, 2006

(54) Scanning device and device having lid

(76) Inventors: Kun-Yee Yang, Banciao City (TW); Shao-Kui Lin, Changchiakang Shi (CN)

Correspondence Address: RABIN & Berdo, PC, 1101 14TH STREET, NW, SUITE 500, WASHINGTON, DC, 20005, US

(21) Appl. No.: 11/449,697

(22) Filed: Jun. 9, 2006

(30) Foreign Application Priority Data
Jun. 10, 2005 (TW) 94119411

(51) Int. Cl. G01J 1/04

(52) U.S. Cl. 250/237 R

(57) ABSTRACT

A scanning device including a main body, a lid and an extendable plate is provided. The lid is pivotally connected to the main body. The extendable plate has a first side and a second side. The first side is fixed on the lid, and the second side is pivotally connected to the main body. When the lid is rotated with respect to the main body, the extendable plate is extended.

This application claims the benefit of Taiwan application Serial No. 094119411, filed on Jun. 10, 2005, the subject matter of which is incorporated herein by reference.

### BACKGROUND OF THE INVENTION

1. Field of the Invention

The invention relates in general to a device having a lid, and more particularly to a scanning device for preventing from the sliding of documents.

2. Description of the Related Art

Scanner has become an indispensable device of the peripheral personal computers no matter the user is an individual or an institution. Scanner is an image capturing device for scanning photos, text page, pictures, illustrations, and some three-dimensional objects such as coins or textile fabrics and then converting the scanned data into digital formats that can be displayed, edited, stored, inputted or outputted by computers. A scanner can do a lot of jobs. For example, a scanner can scan and incorporate pictures and photos into a document, scan a text into a word processing software thus saving the time of retyping the text, scan a facsimile document and store the data in a database or a word processing software, or incorporate data and images to better present the topics.

When scanning an object, the user needs to prepare additional space apart from the space for the placing scanner. For example, part of the space on the desk is required for placing the to-be-scanned photos, pictures or documents, and another space is required for placing photos, pictures or documents which have been scanned. Although the scanner itself does not occupy a large space, however, extra space would be required when using the scanner. In order to space, vertical-type or wall hanging scanners are provided. FIG. 1 is a side view of a conventional vertical-type scanner when a lid is opened. Referring to FIG. 1, a conventional vertical-type scanner 10 includes a main body 11, a lid 12, a plate 13 and a bracket 16. When the bracket 16 is extended and contain an angle with the main body 11, the scanner 10 can be placed on a platform vertically. The main body 11 has a scanning window 15 for placing a to-be-scanned document. A plate 13 is disposed on an inner surface of the lid 12 which is pivotally connected to the main body 11 and is covered by a layer of sponge 14. When scanning a document, the lid 12 is mounted on the main body 11 for retaining the document, and the plate 13 which is covered by the sponge 14 helps to spread the document smoothly on the scanning window 15.

However, when the lid 12 is opened, the document, no more retained by the lid 12, is likely to slide towards the pivotal joint between the lid 12 and the main body 11. Consequently, the document may come off the scanner through the gap of the pivotal joint, or the document may block the pivotal joint causing the lid 12 unable to rotate, and resulting in inconvenience of use. For example, when placing a document, the user has to close the lid 12 with one hand immediately after the other hand is removed from the to-be-scanned document, lest the document might fall to the pivotal joint from the scanning window 15. Thus, the to-be-scanned document is precisely retained on the scanning window 15. When the lid is opened after scanning has been completed, the user has to grasp the document timely lest the document might come off the scanner through the gap of the pivotal joint.

### SUMMARY OF THE INVENTION

It is therefore an object of the invention to provide a scanning device with an extendable plate disposed between the lid and the main body. When the lid is rotated with respect to the main body, the extendable plate is correspondingly extended or compressed as the distance between the lid and the main body changes. The extendable plate is positioned between the scanning window and the pivotal joint, the extendable plate prevents the document from sliding towards the pivotal joint particularly when the scanning device is a vertical-type or a wall-hanging type scanning device.

The invention achieves the above-identified object by providing a scanning device. The scanning device includes a main body, a lid and an extendable plate is provided. The lid is pivotally connected to the main body. The extendable plate has a first side and a second side. The first side is fixed on the lid, and the second side is pivotally connected to the main body. When the lid is rotated with respect to the main body, the extendable plate is extended.

The invention achieves the above-identified object by providing another device having a lid. The device includes a main body, a lid, a first plate, a second plate and at least an elastic component. The lid is pivotally connected to the main body of the device. The first plate has a first side fixed on the lid. The second plate has a second side pivotally connected to the main body. The at least elastic component connects the first plate and the second plate. When the lid is rotated with respect to the main body of the device, the at least elastic component is extended for connecting the first plate and the second plate which are departed from each other.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a side view of a conventional vertical-type scanner when a lid is opened.

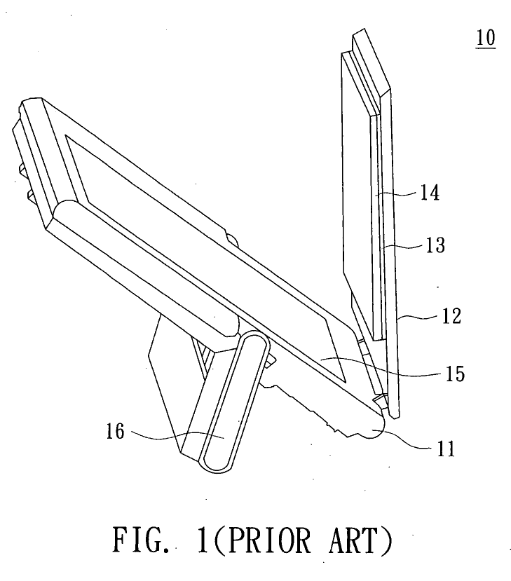

FIG. 2A is a perspective diagram of a scanning device according to a first embodiment of the invention when a lid forms an acute angle with a main body.

FIG. 2B is a partial enlarged view of an extendable plate of a scanning device in FIG. 2A.

FIG. 2C is a front view of an extendable plate of a scanning device in FIG. 2A.

FIG. 3A is a side view of a scanning device according to a first embodiment of the invention when a lid is closed.

FIG. 3B is a front view of an extendable plate of a scanning device in FIG. 3A.

FIG. 4A is a side view of a scanning device according to a first embodiment of the invention when a lid forms an obtuse angle with a main body.

FIG. 4B is a front view of an extendable plate of a scanning device in FIG. 4A.

FIG. 5A is a partial perspective diagram of an extendable plate of a scanning device according to a second embodiment of the invention when a lid is closed to a main body.

FIG. 5B is a partial perspective diagram of an extendable plate of a scanning device according to a second embodiment of the invention when a lid is opened from a main body.

### DETAILED DESCRIPTION OF THE INVENTION

The main concept of the invention lies in disposing an extendable plate between the lid and the main body. When the lid is rotated with respect to the main body, the extendable plate is correspondingly extended or compressed in response to the change in the distance between the lid and the main body. Particularly when the scanning device is a vertical type or wall-hanging type scanner, the extendable plate is for preventing the document from sliding towards the pivotal joint. A scanning device is exemplified below. However, the application of the invention is not limited to the scanning device. The invention is applicable to any device having lid, such as a copy machine or a multi-function office machine.

### FIRST EMBODIMENT

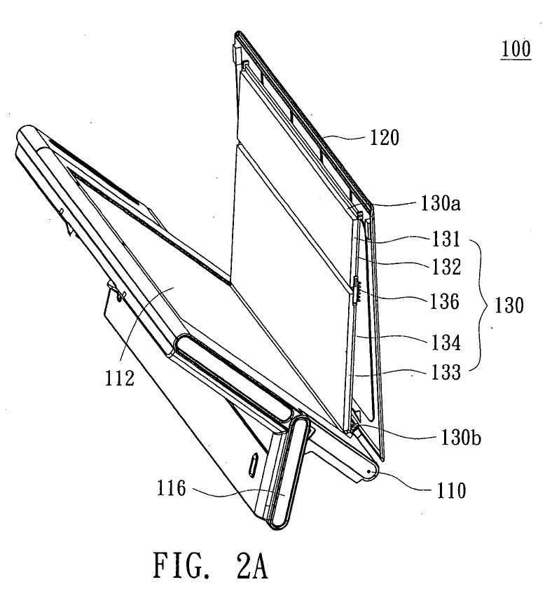

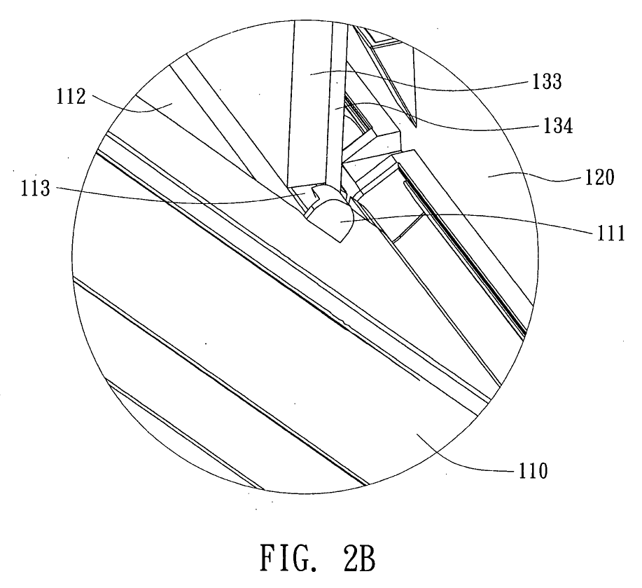

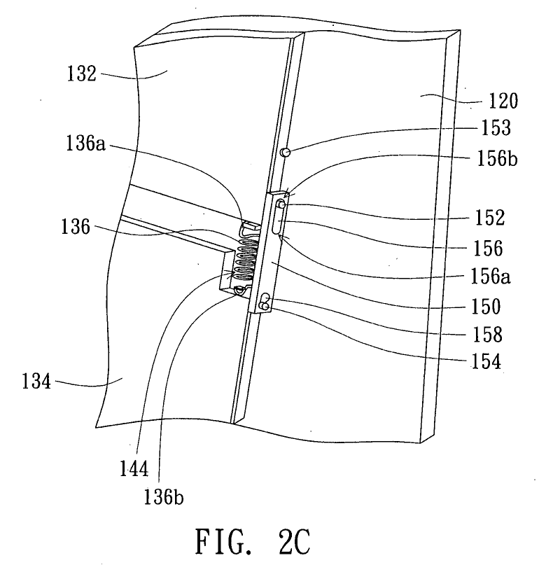

Referring to FIG. 2A, a perspective diagram of a scanning device according to a first embodiment of the invention when a lid forms an acute angle with a main body is shown. Scanning device 100 includes a main body 110, a lid 120 and an extendable plate 130. The lid 120 is pivotally connected to the main body 110. The extendable plate 130 has a first side 130a and a second side 130b. The first side 130a is fixed on the lid 120, and the second side 130b is pivotally connected to the main body 110.

The scanning device further includes a bracket 116 pivotally connected to the main body 110. When the bracket 116 is rotated and forms an angle with the main body 11, the scanner 100 is vertically placed on an operating plafform. The main body 110 has a scanning window 112 is for placing a to-be-scanned document, so that the scanning module of the main body 110 is able to scan the document via the scanning window 112. The second side 130b of the extendable plate is adjacent to the scanning window 112.

The extendable plate 130 includes a first plate 132, a second plate 134 and an elastic component 136. The first plate 132 is fixed on the lid 110, and the second plate 134 is pivotally connected to the main body 110. FIG. 2B is a partial enlarged view of an extendable plate of a scanning device in FIG. 2A. The main body further includes a pivotal joint 111. The second plate 130 includes a spindle 113, which can be rotatably connected to the pivotal joint 111, so that the second plate 130 is pivotally connected to the main body 110. The elastic component 136 connects the first plate 132 and the second plate 134.

The extendable plate 130 further includes a first buffering component 131 and a second buffering component 133. The first buffering component 131 is mounted on the first plate 132, and the second buffering component 133 is mounted on the second plate 134. Preferably, the first buffering component 131 and the second buffering component 132 are made of sponge. Besides, the area of the first buffering component 131 is substantially the same with the area of the first plate 132, and the area of the second buffering component 133 is substantially the same with the area of the second plate 134.

Referring to FIG. 2C, a front view of an extendable plate of a scanning device in FIG. 2A is shown. The second plate 134 has a recess 144 for receiving the elastic component 136. The elastic component 136, a spring or an elastic piece for instance, has a first end 136a and a second end 136b respectively fixed on the first plate 132 and the recess 144 of the second plate 134. The scanning device 100 further includes a restricting component 150, a first bump 152 and a second bump 154. The restricting component 150 has a guide slot 156 and a hole 158. There area first position 156a and a second position 156b in the guide slot 156. The first bump 152 is disposed on the first plate 132 and positioned in the guide slot 156. The second bump 154 is disposed on the second plate 134 and positioned in the hole 158. The restricting component 150 is for restricting the course of movement of the first plate 152 and the second plate 154.

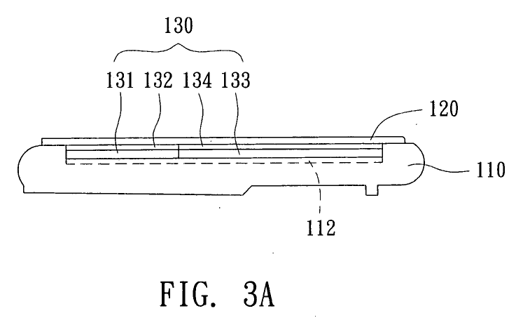

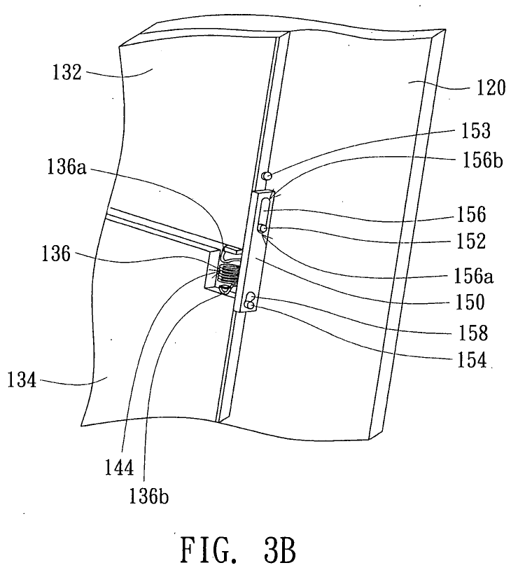

FIG. 3A is a side view of a scanning device according to a first embodiment of the invention when a lid is closed. Referring to both FIG. 3A and FIG. 3B, when the lid 120 is close and covers the main body 110, the extendable plate 130 is hold between the lid 120 and the main body 110, the first buffering component 131 is hold between the scanning window 112 and the first plate 132, and the second buffering component 133 is hold between the scanning window 112 and the second plate 134. By means of the first buffering component 131 and the second buffering component 133 respectively disposed on the first plate 132 and the second plate 134 of the extendable plate 130, the to-be-scanned document is smoothly spread over the scanning window 112. Meanwhile, the extendable plate 130 shields the light and further enhances the quality of image scanning. Since the extendable plate 130 is at a compressed state and overlaps with the scanning window 112 correspondingly, the area of the extendable plate 130 is preferably equal to the area of the scanning window 112. FIG. 3B is a front view of an extendable plate of a scanning device in FIG. 3A. Referring to FIG. 3B, when the extendable plate 130 is at a compressed state, the first bump 152 is positioned in the first position 156a of the guide slot 156, the elastic component 136 is at an initial state (i.e. receiving not any applied force) and is received in the recess 144, and the first plate 132 leans against the second plate 134.

Referring to FIG. 2A, when the lid 120 is rotated with respect to the main body 110, the lid 120 urges the extendable plate 130 to rotate with respect to the main body 110 and makes the extendable plate 130 to be extended. When the scanning device 100 is placed vertically on the desk in order to save more space, the second plate 134 is particularly able to block the to-be-scanned document positioned on the scanning window 112 which has a tendency sliding towards the pivotal joint between the lid 120 and the main body 110. When the lid 120 is open, the user does not have to immediately grasp the document to prevent it from sliding towards or blocking the pivotal joint. Thus, the extendable plate 130 prevents the document from falling downward, largely enhancing convenience of use.

Referring to FIG. 2C, when the extendable plate 130 is extended, the elastic component 136 is also extended for connecting the first plate 132 and the second plate 134 which are departed from each other. Meanwhile, the first bump 152 slides to the second position 156b from the first position 156a along the guide slot 156, the first plate 132 moves with respect to the second plate 134 and keeps a pre-determined distance from the second plate 134, and a pre-determined angle is formed between the lid 120 and the main body 110 as shown in FIG. 2C. The lid 120 can only be rotated within the range of the pre-determined angle, because the course of movement of the first plate 152 and the second plate 154 is restricted by the restricting component 150. The design, restricting the rotation of the lid 120 to be within a pre-determined angle, of the scanning device not only shrinks the operating space but also dispenses the step of opening and closing the lid to a large but unnecessary angle, largely increasing convenience of operation. Lid 120 of wall-hanging scanning device 100 trends to 180o rotation with the main body due to gravity. If the lid's maximum angle of rotation is restricted, the lid (with a fixed angle which is less than or equal to 90 degree with the main body) is capable of supporting a document, largely increasing the practicality of product.

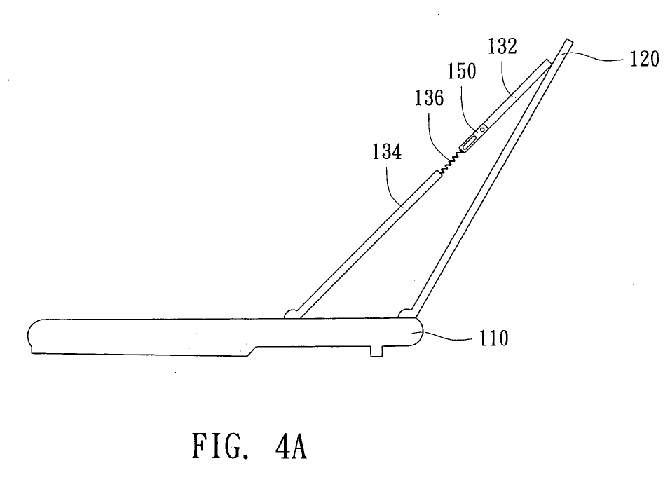

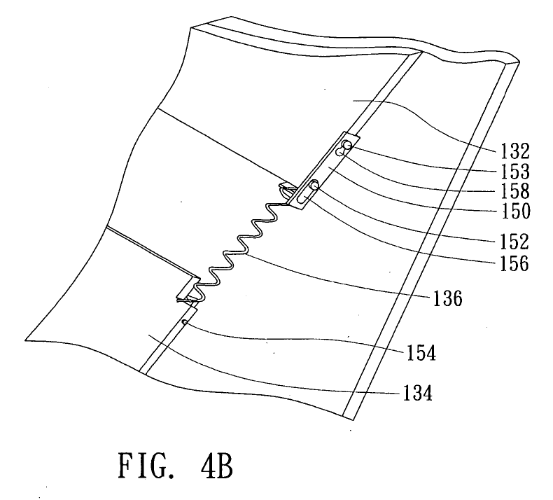

FIG. 4A is a side view of a scanning device according to a first embodiment of the invention when a lid forms an obtuse angle with a main body. FIG. 4B is a front view of an extendable plate of a scanning device in FIG. 4A. If the user would like to continue to rotate the lid 120 to form an angle between the lid 120 and the main body 110 larger than the pre-determined angle as shown in FIG. 4A, the restricting component 150, which is used for restricting the course of movement between the first and second plated 132 and 134, has to be removed first in order to release the first plate 132 and the second plate. For example, the restricting component 150 is moved to the first plate 132. Referring to FIG. 4B, the first plate 132 further includes a third bump 153. The first bump 152 and the third bump 153 of the first plate 132 are respectively mounted in the guide slot 156 and the hole 158 of the restricting component 150. Thus, the first plate 132 and the second plate 134 can be moved freely and so can the lid be rotated freely.

### SECOND EMBODIMENT

The present embodiment differs with the first embodiment only in the way of connection between the first plate and the second plate. As for other similar elements are not repeated here.

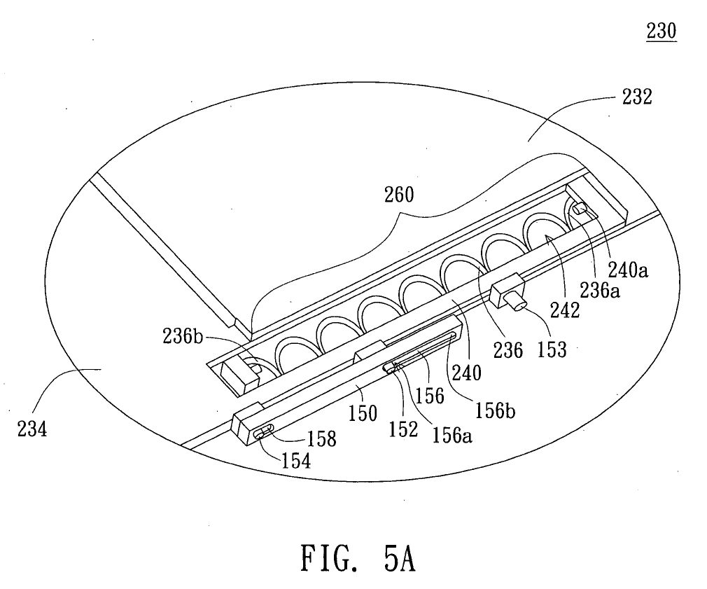

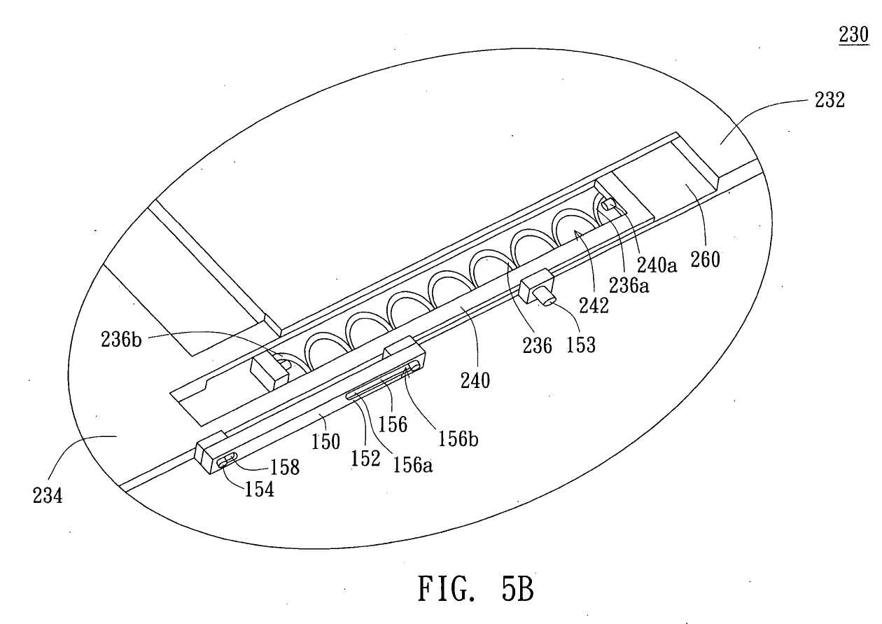

Referring to FIG. 5A, a partial perspective diagram of an extendable plate of a scanning device according to a second embodiment of the invention when a lid is closed to a main body is shown. The extendable plate 230 of the present embodiment further includes a protrusion 240 and a slid slot 260. The protrusion 240 is projected from the second plate 234. The slid slot 260 is disposed on the first plate 232 for receiving the protrusion 240. When the first plate 232 leans against the second plate 234, the protrusion 240 is correspondingly positioned in the slid slot 260.

The protrusion 240 has an opening 242 and a protruded end 240a. The protruded end 240a and the first plate 232 overlap each other. The opening 242 is for receiving the elastic component 236. The first end 236a of the elastic component 236 is fixed on the protruded end 240a. For example, the first end 236a is disposed on the wall of the opening 242 of the protruded end 240a as shown in FIG. 5A. The second end 236b of the elastic component 236 is fixed on the first plate 232, so that the elastic component is positioned in the protrusion 240.

The scanning device of the present embodiment further includes a restricting component 150, a first bump 152 and a second bump 154. The restricting component 150 has a guide slot 156 and a hole 158. There are a first position 156a and a second position 156b in guide slot 156. The first bump 152 is disposed on the first plate 232 and positioned in the guide slot 156. The second bump 154 is disposed on the second plate 234 and positioned in the hole 158. The restricting component 150 is for restricting the course of movement of the first plate 252 the second plate 254.

FIG. 5B is a partial perspective diagram of an extendable plate of a scanning device according to a second embodiment of the invention when a lid is opened from a main body. Referring to FIG. 5B, when the lid is open, the first plate 232 is departed from the second plate 234, and the elastic component 236 is compressed. Meanwhile, the first bump 152 slides to the second position 156b from the first position 156a along the guide slot 156, the first plate 232 is moved with respect to the second plate 234 and keeps a pre-determined distance form the second plate 234, so that the lid and the main body contain a pre-determined angle. The course of movement of the first plate 232 the second plate 234 is restricted by the restricting component 150, so that the lid can only be rotated within the range of the pre-determined angle.

The scanning device disclosed in above embodiments of the invention has an extendable plate disposed between the lid and the main body. When the lid is rotated with respect to the main body, the extendable plate is correspondingly extended or compressed as the distance between the lid and the main body changes. The extendable plate is positioned between the scanning window and the pivotal joint, the extendable plate prevents the document from sliding towards the pivotal joint particularly when the scanning device is a vertical-type or a wall-hanging type scanning device. By restricting the rotation of the lid to be within a pre-determined angle which is easy to open and close, not only can the operating space be saved, but also the step of opening and closing the lid to a large but unnecessary angle can be dispensed, largely increasing convenience of operation. Particularly, in terms of a wall-hanging scanning device whose lid is easy to rotate 180° due to gravity, the lid whose maximum angle of rotation is fixed is capable of supporting a document, largely increasing the practicality of product.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning device, comprising:
a main body;
a lid pivotally connected to the main body; and
a extendable plate having a first side and a second side, wherein the first side is fixed on the lid, and the second side is pivotally connected to the main body;
wherein when the lid is rotated with respect to the main body, the extendable plate is extended.

2. The scanning device according to claim 1, wherein the main body has a scanning window, and the second side of the extendable plate is adjacent to the scanning frame;
wherein when the lid is closed and covers the main body, the extendable plate is contained between the lid and the main body, and the extendable plate is at a compressed state and correspondingly overlaps with the scanning window.

3. The scanning device according to claim 2, wherein the extendable plate further comprises:
a first plate is fixed on the lid;
a second plate pivotally connected to the main body; and
at least an elastic component, which has a first end and a second end and is used for connecting the first plate and the second plate.

4. The scanning device according to claim 3, wherein the extendable plate further comprises:
a restricting component having a guide slot and a hole;
a first bump disposed on the first plate and positioned in the guide slot;
a second bump disposed on the second plate and positioned in the hole, whereby the course of movement of the first plate and the second plate is restricted by the restricting component.

5. The scanning device according to claim 3, wherein the first end and the second end are respectively fixed on the first plate and the second plate, and when the extendable plate is extended, the at least elastic component is also stretched.

6. The scanning device according to claim 5, wherein the second plate has a recess for receiving the at least elastic component, and the second end of the at least elastic component is fixed in the recess.

7. The scanning device according to claim 3, wherein the extendable plate further comprises:
a protrusion projected from the second plate, the protrusion having an opening for receiving the at least elastic component, a protruded end of the protrusion overlapping the first plate, a first end of the at least elastic component fixed on the protruded end, and a second end of the at least elastic component fixed on the first plate, so that the at least elastic component is positioned in the protrusion;
wherein when the extendable plate is extended, the first plate is departed from the second plate and the at least elastic component is compressed.

8. The scanning device according to claim 7, wherein the extendable plate further comprises:
a slid slot which is disposed on the first plate for receiving the protrusion;
wherein when the first plate leans against the second plate, the protrusion is correspondingly mounted in the slid slot.

9. The scanning device according to claim 4, wherein there are a first position and a second position in the guide slot;
wherein when the first bump is positioned at the first position, the first plate leans against the second plate and the lid is close and covers the main body;
wherein when the first bump slot slides to the second position along the guide, the first plate is rotated with respect to the second plate, so that a pre-determined angle is contained between the lid and the main body.

10. The scanning device according to claim 9, wherein the extendable plate further comprises:
a third bump disposed on the first plate, wherein the first bump and the third bump are respectively mounted in the guide slot and the hole, so that the lid and the main body form an angle larger than the pre-determined angle.

11. The scanning device according to claim 3, wherein the scanning device further comprises:
a first buffering component mounted on the first plate; and
a second buffering component mounted on the second plate.

12. The scanning device according to claim 11, wherein the first buffering component and the second buffering component are made of sponge.

13. Adevice having a lid, comprising:
a main body;
a lid pivotally connected to the main body;
a first plate having a first side, wherein the first side is fixed on the lid;
a second plate having a second side, wherein the second side is pivotally connected to the main body; and
at least an elastic component for connecting the first plate and the second plate;
wherein, when the lid is rotated with respect to the main body, the at least elastic component is extended for connecting the first plate and the second plate which are departed from each other.

14. The device according to claim 13, wherein the device further comprises:
a restricting component having a guide slot and a hole;
a first bump disposed on the first plate and positioned in the guide slot;
a second bump disposed on the second plate and positioned in the hole, whereby the course of movement of the first plate and the second plate is restricted by the restricting component.

15. The device according to claim 13, wherein the at least elastic component has a first end and a second end respectively fixed on the first plate and the second plate.

16. The device according to claim 15, wherein the second plate has a recess for receiving the at least elastic component, and the second end of the at least elastic component is fixed in the recess.

17. The device according to claim 13, wherein the device further comprises:
a protrusion projected from the second plate, the protrusion having an opening for receiving the at least elastic component, a protruded end of the protrusion overlapping the first plate, a first end of the at least elastic component fixed on the protruded end, and a second end of the at least elastic component fixed on the first plate, so that the at least elastic component is positioned in the protrusion;
wherein when the first plate is departed from the second plate, the at least elastic component is compressed.

18. The device according to claim 17, wherein the device further comprises:
a slid slot which is disposed on the first plate for receiving the protrusion;
wherein when the first plate leans against the second plate, the protrusion is correspondingly mounted in the slid slot.

19. The device according to claim 14, wherein there are a first position and a second position in the guide slot;
wherein when the first bump is positioned at the first position, the first plate leans against the second plate and the lid is close and covers the main body;
wherein when the first bump slides to the second position along the guide slot, the first plate is moved with respect to the second plate, so that a pre-determined angle is contained between the lid and the main body contain.

20. The scanning device according to claim 19, wherein the first plate further comprises:
a third bump, wherein the first bump and the third bump are respectively mounted in the guide slot and the hole, so that the lid and the main body form an angle larger than the pre-determined angle.
